(19) United States
(12) Patent Application Publication
(10) Pub. No.: US 2012/0270514 A1
(43) Pub. Date: Oct. 25, 2012

(54) METHOD AND TERMINAL FOR RECEIVING FM RADIO SIGNALS

(75) Inventors: Yehui Zhang, Shanghai (CN); Yunjuan Zhu, Shanghai (CN); Wenjin Ma, Shanghai (CN)

(73) Assignees: Shanghai Pateo Internet Technology Service Co.,Ltd, Xuhui District, Shanghai (CN); Shanghai Pateo Electronic Equipment Manufacturing Co., Ltd., Xuhui District, Shanghai (CN)

(21) Appl. No.: 13/391,548

(22) PCT Filed: Dec. 25, 2010
(86) PCT No.: PCT/CN2010/080282

§ 371 Date: Feb. 21, 2012

(30) Foreign Application Priority Data
Dec. 31, 2009 (CN) 200910247975.3

(51) Int. Cl. H04B 1/18

(52) U.S. Cl. 455/154.1

(57) ABSTRACT

The present invention provides a method and a terminal for receiving FM radio signals, the method includes: Acquiring a position information of a terminal for receiving the FM radio signals; obtaining a region information of the terminal according to the position information; obtaining a radio station list corresponding to the region information; displaying the radio station list; and broadcasting a radio station which is selected from the radio station list. By the method, the terminal can update the radio station list in time, so that flexibility for receiving radio signals is improved. In addition, if being transferred from one region to another region, the terminal will switch to frequencies of the new region and receive radio signals in the new region with less time.

### CROSS REFERENCE TO RELATED APPLICATIONS

The present application claims the priority of Chinese Patent Application No. 200910247975.3, entitled “Method and Terminal for Receiving FM Radio Signals”, and filed on Dec. 31, 2009, the entire disclosure of which is incorporated herein by reference.

### FIELD OF THE INVENTION

The present invention generally relates to a frequency modulation (FM) radio technology, and more particularly, to a method and a terminal for receiving FM radio signals.

### BACKGROUND OF THE INVENTION

Nowadays, radio is widely applied in transmitting information of news, entertainment programs, and information about education and teaching. With the development of information technology, the television and internet technology are developing rapidly. In spite of that, radio is still a very important way for information transmission because of its low cost and convenience.

As a radio, an FM radio transmits/spreads programs wirelessly. Unlike an AM radio, the FM radio transmits audio signals in a frequency modulation mode. In the FM radio, a frequency of a frequency-modulated wave, corresponding to a carrier wave, varies around a center frequency of the carrier wave (center frequency of the carrier wave un-modulated), with change of audio modulating signals. And the number of times of frequency shift of the frequency-modulated wave in one second is consistent with the modulation frequency of the audio modulating signals. For example, if the frequency of the audio modulating signal is 1 kHz, the number of times of frequency shift of the corresponding frequency-modulated wave is 1000 times per second. In addition, the range of the frequency shift is determined by the amplitude of the audio modulating signals.

The FM radio has the advantages of a strong anti-interference ability, little signal distortion, and a high facility availability, but the FM radio has limited signal coverage. Generally, FM radio stations are divided according to different regions (provinces and cities), and programs broadcast in each FM radio station may only be received in a corresponding region. If being transferred from one region to another region, a terminal for receiving FM radio may have to switch to a receiving frequency of the new region so as to receive programs in the new region.

A method and a terminal for automatically notifying a name of a radio station are disclosed in a Chinese patent application No. 200810142471.0. In the disclosure, after obtaining a position information of the terminal according to wireless cellular signals, the name of the radio station being listened to can be displayed on the terminal. However, the terminal and the method can not display a list of all the radio stations which are available. Therefore, if the terminal position being transferred from one region to another region, because the terminal does not know the frequencies of radio stations in the new region, the terminal has to stop receiving programs and restart to receive programs after searching for signals again, which adversely influences the programs receiving quality of the terminal.

Therefore, there is a need to improve the method and the terminal for receiving FM radio signals in the prior art, in order to avoid an interruption caused by the terminal being transferred from one region to another region while receiving FM radio signals.

### SUMMARY OF THE INVENTION

Embodiments of the present invention provide a method and a terminal for receiving FM radio signals, so as to avoid an interruption caused by the terminal being transferred from one region to another region while receiving FM radio signals.

In order to solve the aforesaid problems, an embodiment of the present invention provides a method for receiving FM radio signals, including:
Acquiring a position information of a terminal for receiving the FM radio signals;
Obtaining a region information of the terminal according to the position information;
Obtaining a radio station list corresponding to the region information;
Displaying the radio station list; and
Broadcasting a radio station which is selected from the radio station list.

Optionally, the position information of the terminal is obtained by a GPS or a mobile-phone base station positioning system.

Optionally, the radio station list is obtained by checking a corresponding relationship between the radio station list and the region information of the terminal.

Optionally, the corresponding relationship between the radio list and the region information of the terminal is stored in a specific storage device.

Optionally, the corresponding relationship between the radio list and the region information of the terminal is updated according to an automatically searching result of radio stations.

Optionally, the corresponding relationship between the radio list and the region information of the terminal includes region names and frequencies of the radio stations.

Optionally, the corresponding relationship between the radio list and the region information of the terminal further includes names of radio stations, program information or signal intensities corresponding to the radio stations.

Optionally, the radio station is selected by following a preset rule or according to requirements of a user.

Optionally, the terminal for receiving FM radio signals updates the position information periodically according to its position.

The embodiments of the present invention further provide a terminal for receiving FM radio signals, including:
A positioning unit, adapted for acquiring a position information of the terminal for receiving FM radio signals;
A region determining unit, adapted for obtaining a region information of the terminal according to the position information;
A storage unit, adapted for storing a corresponding relationship between the region information and a radio station list;
A display unit, adapted for displaying the radio station list;
A main control unit, adapted for searching and finding the radio station list;and
An FM unit, adapted for receiving radio signals of a radio station which is selected from the radio station list.

Optionally, the positioning unit and the region determining unit are integrated in a same module, or the region determining unit and the main control unit are integrated in a same module.

Optionally, the terminal for receiving FM radio signals further includes an input unit which is adapted for inputting a command of the user for selecting a radio station from the radio station list.

Optionally, the positioning unit is a GPS unit or a mobile-phone base station positioning unit.

Optionally, the terminal is a digital FM radio receiver, a mobile-phone with a FM radio function, or a digital player with the FM radio function.

### BRIEF DESCRIPTION OF THE DRAWINGS

FIG. 1 is a schematic diagram for illustrating a flow chart of a method for receiving FM radio signals in an embodiment of the present invention;

FIG. 2 is a schematic diagram for showing a structure of a terminal for receiving FM radio signals in a first embodiment of the present invention;

FIG. 3 is a schematic diagram for showing a structure of a terminal for receiving FM radio signals in a second embodiment of the present invention; and

FIG. 4 is a schematic diagram for showing a structure of a terminal for receiving FM radio signals in a third embodiment of the present invention.

### DETAILED DESCRIPTION OF THE EMBODIMENTS

In order to provide a thorough understanding of the above-mentioned and other objectives, features and advantages of the present invention, embodiments of the present invention will be described hereinafter in conjunction with the attached drawings.

However, the description of illustrated embodiments is not intended to limit the present invention, and equivalent modifications are possible within the scope of this description, as those skilled in the relevant art will recognize.

As described in the background of the invention, if being transferred from one region to another region, a terminal for receiving FM radio signals may have to switch to a receiving frequency of the new region so as to receive programs in the new region. And because the terminal does not know the frequencies of radio stations in the new region, the terminal has to stop receiving programs and restart to search for signals, which adversely influences the signal receiving quality of the terminal.

In order to solve the aforesaid problems, the embodiments of the present invention provide a method and a terminal for receiving FM radio signals. In the method and terminal for receiving FM radio signals, a positioning unit and a corresponding relationship between a region information and a radio station list are involved. According to the positioning unit and the corresponding relationship between the region information and the radio station list, the terminal may update the radio station list of available radio stations in time, thereby improving the flexibility for receiving FM radio signals. Moreover, if the terminal is transferred from one region to another region, because of the radio station list being updated in time, the terminal will switch to frequencies of the new region and receive radio signals in the new region with less time.

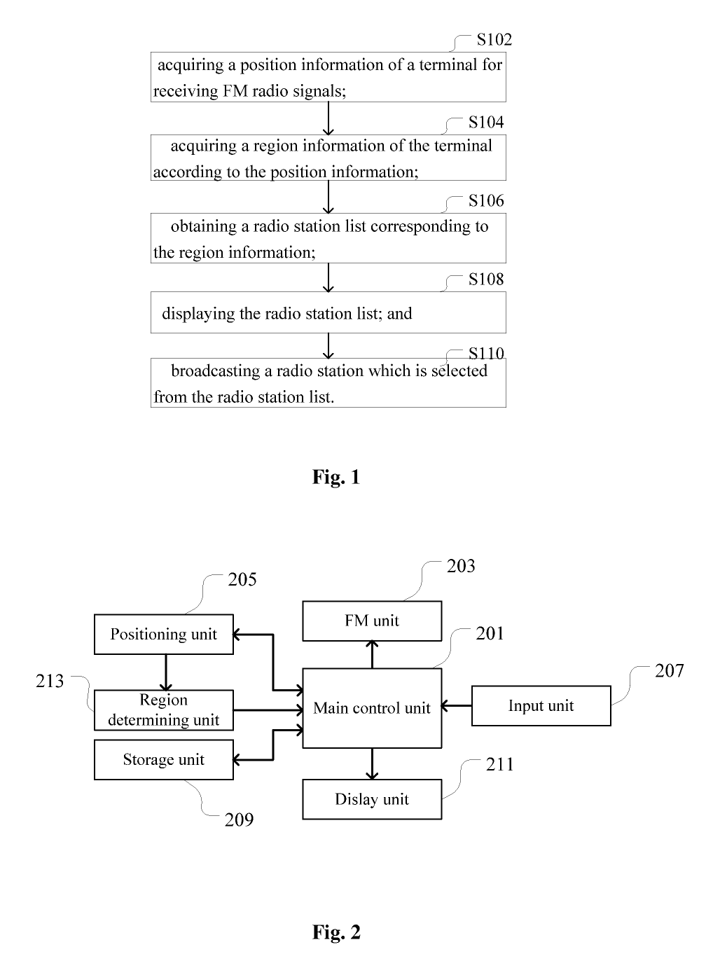

FIG. 1 is a schematic diagram for illustrating a flow chart of a method for receiving FM radio signals in an embodiment of the present invention.

Referring to FIG. 1, the method for receiving FM radio signals includes the following steps.

A step S102 is performed to acquire a position information of a terminal for receiving FM radio signals.

In an embodiment, the terminal may be any kind of FM radio receiver which is portable or easy to be transferred. In an example embodiment, the terminal may be a digital FM radio, a digital player, a cell-phone, or vehicle-mounted radio receiver.

The position information of the terminal may be obtained by using a positioning unit of the terminal. In an embodiment, the position information is obtained by a global positioning system (GPS), a mobile-phone station positioning system, or any other positioning methods. If the position information being obtained by the GPS, the position information includes a longitude information and a latitude information; if the position information being obtained by the mobile-phone station positioning system, the position information may be position information of the base station corresponding to the terminal.

Thereafter, a step S104 is performed to determine a region information according to the position information.

Although available radio stations may be different in different regions, for different places corresponding to a same region, such as different places in a city, available radio stations may be the same. Therefore, to avoid unnecessary operation for updating the radio station list, the position information needs to be converted into a corresponding region information. In an embodiment, the position information is converted into a region information by a specific database in the positioning unit. In another embodiment, the position information may be converted into a region information by another specific processing device which is not integrated in the positioning unit.

Thereafter, a step S106 is performed to determine a radio station list corresponding to the region information.

The terminal inquires and obtains a radio station list corresponding to the region information, according to the region information obtained in S104 and the prestored corresponding relationship between the region information and the radio station list. In an embodiment, the corresponding relationship between the region information and the radio station list is stored in a specific storage device. In another embodiment, the corresponding relationship between the region information and the radio station list is updated according to an automatically searching result of radio stations.

Referring to table 1, the corresponding relationship between the region information and the radio station list is shown as follows:

TABLE 1

| | |
|---|---|
| Regions | Radio station list |

| | | | | |
|---|---|---|---|---|
| Region 1 | Station 11 | Station 12 | Station 13 | . . . |
| Region 2 | Station 21 | Station 21 | Station 21 | . . . |
| Region 3 | Station 31 | Station 31 | Station 31 | . . . |
| . . . | . . . | . . . | . . . | . . . |

As shown in table 1, in an example embodiment, if the region information of the terminal, obtained by the aforesaid method, is Region 1, a radio station list corresponding to Region 1 includes Station 11, Station 12 and Station 13, according to the corresponding relationship.

The corresponding relationship between the region information and the radio stations may be in different formats. In an embodiment the corresponding relationship may at least include region names and frequencies of the radio stations. The region name is corresponding to the position information of the terminal, and frequencies of the radio stations may be sent to the FM unit of the terminal to determine a receiving frequency.

In another embodiment, the corresponding relationship may further include names of the radio stations, program information and signal intensities, and so on. The names of the radio stations may help a user easy to recognize it. The program information, which will be updated depending on time period, may help a user to learn programs being or to be broadcast on each radio station, and to select an appropriate program to listen to. And the signal intensities provide a user with information of signal receiving quality of each radio station.

Thereafter, a step S108 is performed to display the radio station list.

After obtainment of the radio station list, the radio station list is displayed through a display unit for notifying a user.

In an embodiment, after the terminal is started, a positioning operation is performed immediately, and the radio station list is updated according to the change of the region information. In an example embodiment, the terminal updates the position information periodically according to its position, converts the position information to the region information, and then compares the region information with a historical region information. If the region information is different from the historical region information, the radio station list will be updated and the new radio station list corresponding to the region information will be displayed on the display unit. If the region information is the same as the historical region information, the radio station list will not be updated or only some information of the radio station list will be updated, such as program information varying with time.

Thereafter, a step S110 is performed to broadcast a radio station which is selected from the radio station list.

In an embodiment, after obtaining the radio station list, a radio station may be selected to broadcast. The processing for selecting the radio station may be performed by following a preset rule. In an example embodiment, a radio station with the greatest signal intensity may be selected to broadcast. In another example embodiment, the radio station may be selected by a user according to personal interest of the user after the user learns about the available radio stations in the radio station list. Moreover, in order to facilitate the user, the radio station information may be displayed on the display unit after a radio station is selected.

FIG. 2 is a schematic diagram for showing a structure of a terminal for receiving FM radio signals in a first embodiment of the present invention.

Referring to FIG. 2, the terminal for receiving FM radio signals includes: A main control unit 201, an FM unit 203, a positioning unit 205, a storage unit 207, an input unit 209, a display unit 211 and a region determining unit 213. The FM unit 203, the positioning unit 205, the storage unit 207, the input unit 209, the display unit 211 and the region determining unit 213 are coupled to the main control unit 201.

The positioning unit 205 is adapted for acquiring the position information of the terminal. In an embodiment, the positioning unit 205 may be a GPS positioning unit, a mobile-phone base station positioning unit, or any other positioning unit, preferably, the positioning unit 205 is a GPS positioning unit.

The region determining unit 213 is adapted for obtaining a region information of the terminal according to the position information of the terminal.

The storage unit 209 is adapted for storing a corresponding relationship between the region information and a radio station list.

The display unit 211 is adapted for displaying a radio station list.

The main control unit 201 is adapted for searching and determining a radio station list corresponding to the region information.

The FM unit 203 is adapted for receiving radio signals from a radio station which is selected from the radio station list.

The input unit 207 is adapted for the user inputting a command for selecting a radio station from the radio station list.

After the terminal is started, the main control unit 201 sends a position information request to the positioning unit 205, then the positioning unit 205 performs a positioning operation to acquire the position information of the terminal according to the position information request, then the region determining unit 213 determines the corresponding region information according to the position information sent by the positioning unit 205 and sends the region information to the main control unit 201, then the main control unit 201 searches the corresponding relationship between the region information and a radio station list stored in the storage unit 209 after receiving the region information and determines a radio station list corresponding to the region information, and sends the radio station list to the display unit 211 which displays the radio station list for the user.

In an embodiment, the user may send a selecting command through the input unit 207 according to the radio stations displayed by the display unit 211, so as to select a radio station which the user wants to listen to. Moreover, the information about the selected radio station is displayed by the display unit 211, and radio signals from the selected radio station are received by the FM unit 203. In another embodiment, the command for selecting the radio station may be performed according to a preset rule. In an example embodiment, the rule is to select a radio station with the greatest signal intensity to broadcast.

The co-operation between the units described above is corresponding to an initialization process of the terminal. The position information of the terminal may change with time, so the main control unit 201 needs to send the position information request periodically. The positioning unit 205 updates the position information according to the position information request. Thereafter, the region determining unit determines the corresponding region information according to the position information. If the new region information is different from the historical region information, the radio station list will be updated and an updated radio station list corresponding to the region information will be displayed in the display unit 211. If the region information is the same as the historical region information, the radio station list will not be updated and the state of the terminal will not be changed.

In an embodiment, the terminal may be any kind of FM radio receiver which is portable or easy to be transferred. In an example embodiment, the terminal may be a digital FM radio, a digital player, a cell-phone, or vehicle-mounted radio receiver.

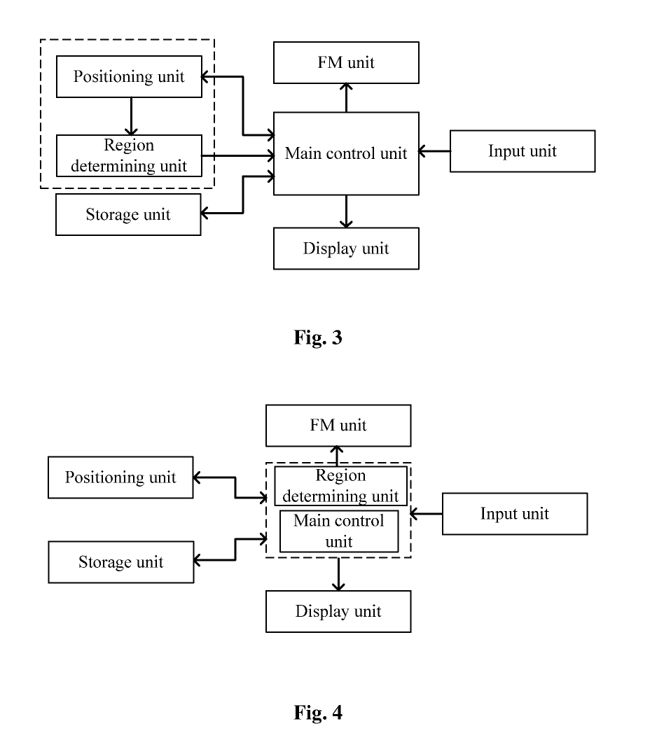

FIG. 3 is a schematic diagram for showing a structure of a terminal for receiving FM radio signals in a second embodiment of the present invention.

Referring to FIG. 3, the terminal for receiving FM radio signals in another embodiment of the present invention includes: A main control unit, an FM unit, a positioning unit, a storage unit, an input unit, a display unit and a region determining unit. The functions of the units are the same as those in FIG. 2, and the region determining unit and the positioning unit are integrated in the same module.

FIG. 4 is a schematic diagram for showing a structure of a terminal for receiving FM radio signals in a third embodiment of the present invention.

Referring to FIG. 4, the terminal for receiving FM radio signals in another embodiment of the present invention includes: A main control unit, an FM unit, a positioning unit, a storage unit, an input unit, a display unit and a region determining unit. The functions of the units are the same as those in FIG. 2, and the region determining unit and the main control unit are integrated in the same module.

According to the embodiments of the present invention, the terminal and method for receiving FM radio signals adopts a positioning unit and a database for storing a corresponding relationship between a region information and a radio station list. According to the positioning unit and the database for storing the corresponding relationship between region information and a radio station list, the terminal can update the available radio station list in time, which improves the flexibility for receiving radio signals. Moreover, if the terminal is transferred from one region to another region, because of the radio station list being updated in time, the terminal will switch to frequencies of the new region and receive radio signals in the new region with less time.

Although the present invention has been disclosed as above with reference to preferred embodiments, it is not intended to limit the present invention. Those skilled in the art may modify and vary the embodiments without departing from the spirit and scope of the present invention. Accordingly, the scope of the present invention shall be defined in the appended claim.

1. A method for receiving FM radio signals, comprising:
acquiring a position information of a terminal for receiving the FM radio signals;
obtaining a region information of the terminal according to the position information;
obtaining a radio station list corresponding to the region information;
displaying the radio station list; and
broadcasting a radio station which is selected from the radio station list.

2. The method for receiving FM radio signals according to claim 1, wherein the position information of the terminal is obtained by a GPS or a mobile-phone base station positioning system.

3. The method for receiving FM radio signals according to claim 1, wherein the radio station list is obtained by checking a corresponding relationship between the radio station list and the region information of the terminal.

4. The method for receiving FM radio signals according to claim 1, wherein the corresponding relationship between the radio list and the region information of the terminal is stored in a specific storage device.

5. The method for receiving FM radio signals according to claim 4, wherein the corresponding relationship between the radio list and the region information of the terminal is updated according to an automatically searching result of radio stations.

6. The method for receiving FM radio signals according to claim 3, wherein the corresponding relationship between the radio list and the region information of the terminal comprises region names and frequencies of the radio stations.

7. The method for receiving FM radio signals according to claim 6, wherein the corresponding relationship between the radio list and the region information of the terminal further comprises names of radio stations, program information or signal intensities corresponding to the radio stations.

8. The method for receiving FM radio signals according to claim 1, wherein the radio station is selected by following a preset rule or according to requirements of a user.

9. The method for receiving FM radio signals according to claim 1, wherein the terminal for receiving FM radio signals updates the position information periodically according to its position.

10. A terminal for receiving FM radio signals, comprising:
a positioning unit, adapted for acquiring a position information of the terminal for receiving FM radio signals;
a region determining unit, adapted for obtaining a region information of the terminal according to the position information;
a main control unit, adapted for searching and finding a corresponding radio station list;
a storage unit, adapted for storing a corresponding relationship between the region information and the radio station list;
a display unit, adapted for displaying the radio station list; and
an FM unit, adapted for receiving radio signals of a radio station which is selected from the radio station list.

11. The terminal for receiving FM radio signals according to claim 10, wherein the positioning unit and the region determining unit are integrated in a same module, or the region determining unit and the main control unit are integrated in a same module.

12. The terminal for receiving FM radio signals according to claim 10, further comprising an input unit, wherein the input unit is adapted for inputting a command of the user for selecting a radio station from the radio station list.

13. The terminal for receiving FM radio signals according to claim 10, wherein the positioning unit is a GPS unit or a mobile-phone base station positioning unit.

14. The terminal for receiving FM radio signals according to claim 10, wherein the terminal is a digital FM radio receiver, a mobile-phone with a FM radio function, or a digital player with the FM radio function.
